(19) United States
(12) Patent Application Publication
(10) Pub. No.: US 2016/0224837 A1
(43) Pub. Date: Aug. 4, 2016

(54) Method And System For Facial And Object Recognition Using Metadata Heuristic Search

(71) Applicant: Hyperlayer, Inc., Portland, OR (US)

(72) Inventors: Dan Lipert, Portland, OR (US); Laura Andrews, Portland, OR (US); William Weinstein, Portland, OR (US)

(21) Appl. No.: 14/064,069

(22) Filed: Oct. 25, 2013

(51) Int. Cl. G06K 9/00; G06F 17/30; G06K 9/62

(52) U.S. Cl. CPC G06K 9/00771; G06K 9/00288; G06K 9/00255; G06K 9/6267; G06F 17/30256; G06F 17/3053; G06K 2009/00328

(57) ABSTRACT

A method and system for real-time object and facial recognition is provided. Multiple video or camera data feeds are used to collect information about a location and transmitted to a distributed, web-based framework. The system is adaptive and compiles the metadata from the visual queries and stores the metadata and images in multiple relational databases. The metadata is used heuristically, wherein the rank-ordering of matching-candidates is neural; thereby, reducing the number of comparisons (object or face) needed for recognition, and increasing the speed of the recognition. Employing multiple, web-linked servers and databases improves recognition speed and removes the need for each user to create and maintain a facial recognition system, allowing users to consume and contribute to a vast pool of private or public, geo-located data.

### BACKGROUND OF THE INVENTION

The present invention relates generally to surveillance technology, and more specifically to collecting, linking, and processing image data to identify faces or objects from real-time and historical surveillance data.

Closed circuit video surveillance is commonplace and used to monitor activity in sensitive locations. In large facilities, such as casinos, security personnel will monitor screens displaying the video feed hoping to identify suspicious behavior and prevent crime. Should a crime occur, law enforcement can only review the recorded video footage after the crime/suspicious activity has occurred. Unfortunately, with closed video surveillance, companies are forced to have personnel watching numerous screens (or closed circuit televisions) 24 hours a day. The job is monotonous and important data simply goes unidentified. Law enforcement is also operating at a disadvantage with current surveillance systems, left to comb through hours of surveillance video after a crime has occurred, with no ability to identify and intercept suspects during (or before) the commission of a crime.

In recent years technological advances combined with an ever-increasing sophisticated criminal environment have allowed biometric identification systems to become more prevalent. However, the high cost, lengthy recognition delays, and excessive memory storage, of facial recognition, fingerprint recognition, iris scanning, etc., continues to limit their applications.

### SUMMARY OF THE INVENTION

The present invention is a system and method for collecting, linking, and processing image data to identifying faces or objects from real-time and historical surveillance data. It is an object of the present invention to improve the system and method of identification of individuals and/or objects from visual queries via non-biometric, metadata. A visual query can comprise numerous image data sources. The data is then sent to a server system having one or more processors and memory to store one or more programs and/or applications executed by one or more of the processors. The method includes compiling an identification profile for each person in the captured video. To limit CPU and power usage, no recognition or storage needs to occur at the device level. The data can be categorized, correlated, and/or indexed in remote relational databases for a variety of purposes. The pool from which matching-candidates can be selected can be private or public databases. Eliminating unlikely candidates or entries through metadata either obtained through manual entry, running SLAM algorithms, and/or extracted from the video data (in which the metadata is already embedded) allows the present invention to minimize the number of one-to-many verification events for facial or object recognition. The system's novel rank-ordering of user databases occurs dynamically, wherein the system learns and returns results based on an subscriber's required confidence level. Utilizing cloud computing, the present invention massively improves the time needed to regenerate datasets compared with a typical data-center hosting solution, and keeps costs low by automatically scaling servers up to create datasets, and shutting them off when analysis is complete. Individuals are identified quickly and results/identifying information can be sent directly to the users' computers or smart phones. The present invention not only provides identifying information about the person or object received in the visual query, but can also provide a variety of data or information about the identified individual/object.

### BRIEF DESCRIPTION OF THE DRAWINGS

FIG. 1 is an exemplary architecture for the system of facial recognition of the present invention;

FIG. 2 illustrates an example server architecture for the system used to perform the facial recognition of the present invention;

FIG. 3 is a process flow of an example method for the face recognition of the present invention;

FIG. 4 illustrates an exemplary environment employing the system and method of facial recognition of the present invention; and

FIG. 5 is an example computer system of the present invention.

### DETAILED DESCRIPTION

In one example one or more systems may be provided with regard to facial/object recognition using a metadata heuristic search. In another example, one or more methods may be provided with regard to facial/object recognition using metadata heuristic search. The present invention is computer implemented and generally is an online service, platform, or website that provides the functionality described herein, and may comprise any combination of the following: computer hardware, computer firmware, and computer software. Additionally, for purposes of describing and claiming the present invention as used herein the term “application” and/or “program” refers to a mechanism that provides the functionality described herein and also may comprise any combination of the following: computer hardware, computer firmware, and computer software. The examples discussed herein are directed towards visual queries for facial recognition; however, it should be understood that “object” could replace “facial” in all instances without departing from the scope of the invention.

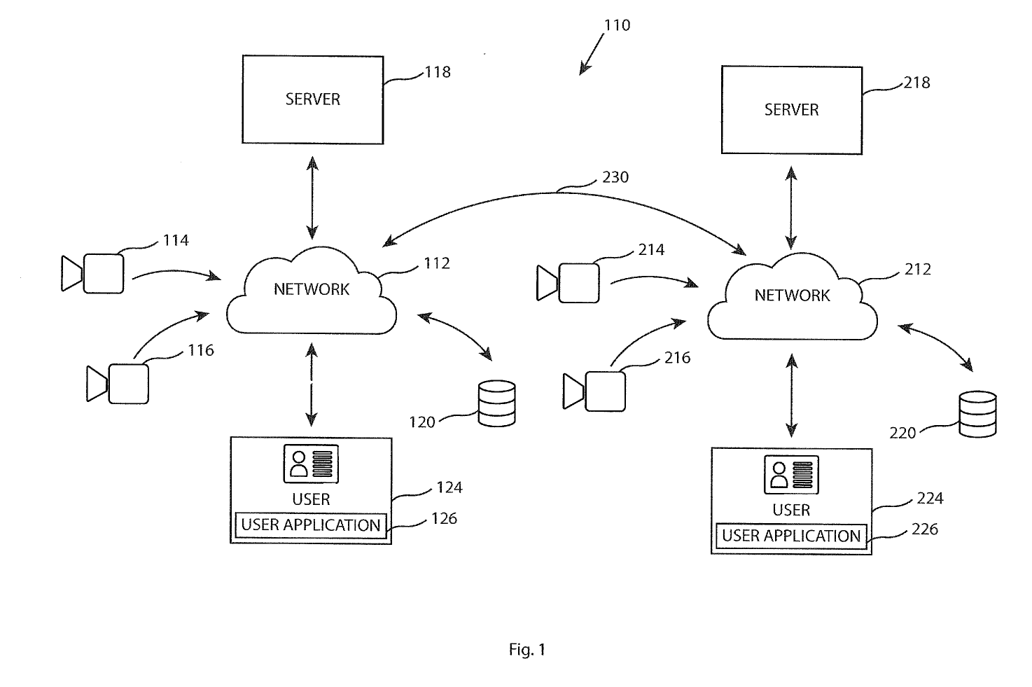

FIG. 1 illustrates an exemplary architecture of the facial recognition system 110 of the present invention. Recognition system 110 comprises a network 112, which is the medium used to provide communication links between various devices and computers within the recognition system 110. System 110 comprises a peer-to-peer architecture for increased reliability and uptime. The network 112 may be the Internet, a wireless network such as a mobile device carrier network, a wired network, or any other network, or combinations of networks that can be used for communication between a peer and a server. In many applications a private network, which may use Internet protocol, but is not open to the public will be employed. Cameras 114 and 116 are connected to network 112, as is server 118, remote database 120, and user 124. The peer-to-peer architecture allows additional cameras, servers, and users to be added to recognition system 110 for quick expansion.

Video cameras 114 and 116 can operate in the infrared, visible, or ultraviolet range of the electromagnetic spectrum. While depicted as video cameras in FIG. 1, the present invention can also employ a camera that records still images only. Cameras 114 and 116 may or may not include light amplification abilities. Cameras 114 and 116 are peers of server 112. Cameras 114, 116 can be used at stationary surveillance locations such as intersections, toll booths, public or private building entrances, bridges, etc., or can be mobile, mounted in enforcement vehicles, taxi cabs, or any mobile vehicle. Cameras 114, 116 can be fixed or employ pan/tilt/zoom capabilities.

User system 124 is a peer of server 118 and includes a user application 126. User application 126 is executed by user 124 for submitting/sending visual queries and receiving data from server 118. User system 124 can be any computing device with the ability to communicate through network 112, such as a smart phone, cell phone, a tablet computer, a laptop computer, a desktop computer, a server, etc. User system 124 can also include a camera (not illustrated) that provides image data to server 118. A visual query is image data that is submitted to server 118 for searching and recognition. Visual queries can include but are not limited to video feeds, photographs, digitized photographs, or scanned documents. Recognition system 110 will often be used as a core to a larger, proprietary analytical solution, and accordingly user application 126 is customizable depending on the needs of the user, such as identifying repeat customers in a retail setting, identifying known criminals at a border crossing, identifying the frequency a specific product occurs at a specific location, identifying product defects, or tracking product inventory. Recognition system 110 can allow separate privately owned (or publicly held) companies and organizations to share data for a joint goal, loss prevention, for example; two large competing retailers may be adversaries when it comes to attracting consumers, but allies when it come to loss prevention Server 118 monitors user system 124 activity and receives the visual query from camera 114 and 116 and/or user system 124, detects faces, extracts metadata from images received, performs simultaneous localization and mapping (SLAM) algorithms, excludes possible candidates based on metadata, performs facial and/or object recognition, organizes results, and communicates the results to user system 124. Remote relational database can store images received from cameras 114, 116, can store metadata extracted from images captured from cameras 114, 116, and can store visual query search results, and reference images captured from cameras 114, 116. Remote databases 122 can be accessed by server 118 to collect, link, process, and identifying image data and the images' associated metadata recorded by cameras 114, 116 at different times.

Continuing with FIG. 1, in the preferred embodiment recognition system 110 also includes a second server 218 communicating with third and fourth cameras 214, 216, second remote database 220, and second user system 224 running second user application 226 through an independent second network 212 (independent of network 112). Cameras 114, 116, third and forth cameras 214, 216 can be fixed or possesses point/tilt/zoom capabilities, can be used from stationary surveillance locations such as intersections, toll booths, public or private building entrances, bridges, etc., or can be mobile, mounted in enforcement vehicles, taxi cabs, or any mobile vehicle. Although not illustrated, individuals walking with a camera, or wearable computing device, for example, can also contribute to the image data being sent to servers 118, 218 in recognition system 110. Server 118 and second server 218 can communicate through a private or public wireless (or wired) connection 230, allowing two different physical locations to share image data. In the present invention various sources of image data are shared and stored at different physical locations and accordingly potential image matches comprise images captured from more than one image source, and are stored in more than one physical location. Potential image matches/matching-candidates could be contained in private databases comprised of historical data compiled by the user or could be gleaned from private or public databases from which the user has been granted access (e.g. local, state, or federal law enforcement databases, Facebook, LinkedIn, etc.) It is important to note that while references images obtained from the image data received from cameras 114, 116, 214, 216, may be stored in databases 122, 220, the data used by the facial recognition algorithms for comparison, may be completely divorced from the image data from which it was obtained. Servers 118, 218 may include memory to store user data, applications, modules, etc., as is well known in the art. In the present invention load output is balanced, by running the expensive computational algorithms required for facial recognition on numerous, parallel servers.

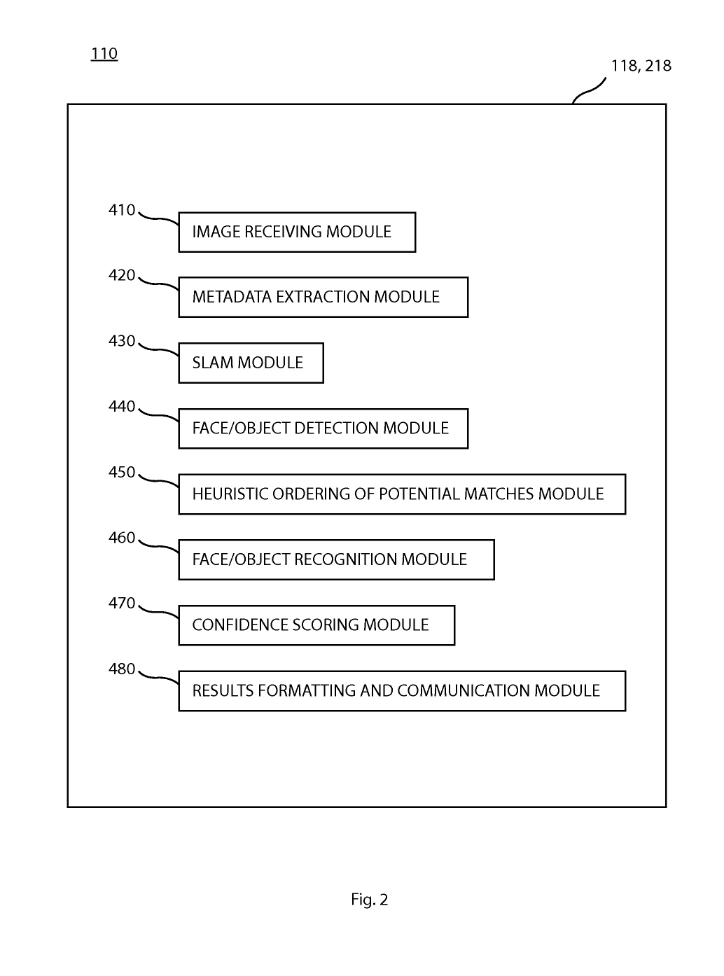

Turning to FIG. 2 example architecture of servers 118 and 218 used to perform the method of face recognition of the present invention is illustrated. Servers 118 and 218 comprise an image-receiving module 410 for receiving video, digital photographs, digitized photographs, or scanned images from the visual query initiated by user systems 124, 224. Metadata extraction module 420 operates upon the images received from the image-receiving module 410, extracting available metadata from the received images, including but not limited to: date, time, GPS coordinates, azimuth, height, lens distortion matrix, pan, tilt, zoom, etc., for storage in databases 122, 222. Since the availability of metadata varies greatly depending on the type of camera used (e.g. webcam vs. digital SLR), should metadata extraction module 420 find no metadata within the received images, SLAM module 430 employs simultaneous location and mapping algorithms to determine angles, height, and location of each camera capturing the images. Information about the location, height, and angle of cameras 114, 116, 214, 216 can also be entered manually into severs 118, 218 of recognition system 110, depending on the needs of the user systems 124, 224. For example, in implementing recognition system 110 in a casino with detailed blueprints of the facility including security camera placement, the location, height, and angle of the security cameras could simply be entered into recognition system 110 manually by a human.

Face detection module 440 operates upon the received images to detect faces in the images. Any number of face detection methods known by those of ordinary skill in the art such as principle component analysis, or any other method, may be utilized. After face detection module 440 detects faces, heuristic ordering module 450 searches and analyzes the metadata extracted from metadata extraction module 420 that has been stored in databases 120, 220 to rank-order the data which corresponds to the people or the objects that might be possible matches (i.e. the person to be identified). Heuristic ordering module 450 is an artificial neural network model, wherein ordering module 450 determines, based on available data, and the confidence level required by the user the best way to search and order the possible matches (i.e., which database is accessed first for possible person or object matches and how much weight is given to the available metadata is not static but dynamic). The rank-ordering accomplished by heuristic ordering module 450, reduces the number of face-to-face (or object-to-object) comparisons recognition module 460 must perform, because instead of a randomly selecting data contained with the database to perform comparisons, recognition module 460 will start with the data that ordering module 450 determines to be the most likely candidate based on the available metadata. Performing fewer face-to-face comparisons, greatly improves the speed at which recognition system 110 recognizes faces (returns results to the user). After heuristic ordering module 450 has ordered the potential image matches (data) for identification, recognition module 460 performs face/object recognition beginning with the most likely candidate based on the rank-ordering determined by module 450. Any conventional technology/algorithms may be employed to recognize of faces/objects in images by recognition methods known by those of ordinary skill in the art. Confidence scoring module 470 quantifies the level of confidence with which each candidate was selected as a possible identification of a detected face. Based on the user's needs of recognition system 110, results formatting and communication module 480, will report the recognition results accordingly. Results formatting and communication module 480 will often be a proprietary business program/application. For example, an application that delivers security alerts to employees cellphones, an application that creates real-time marketing data, sending custom messages to individuals, an application for continuous improvement studies, etc.

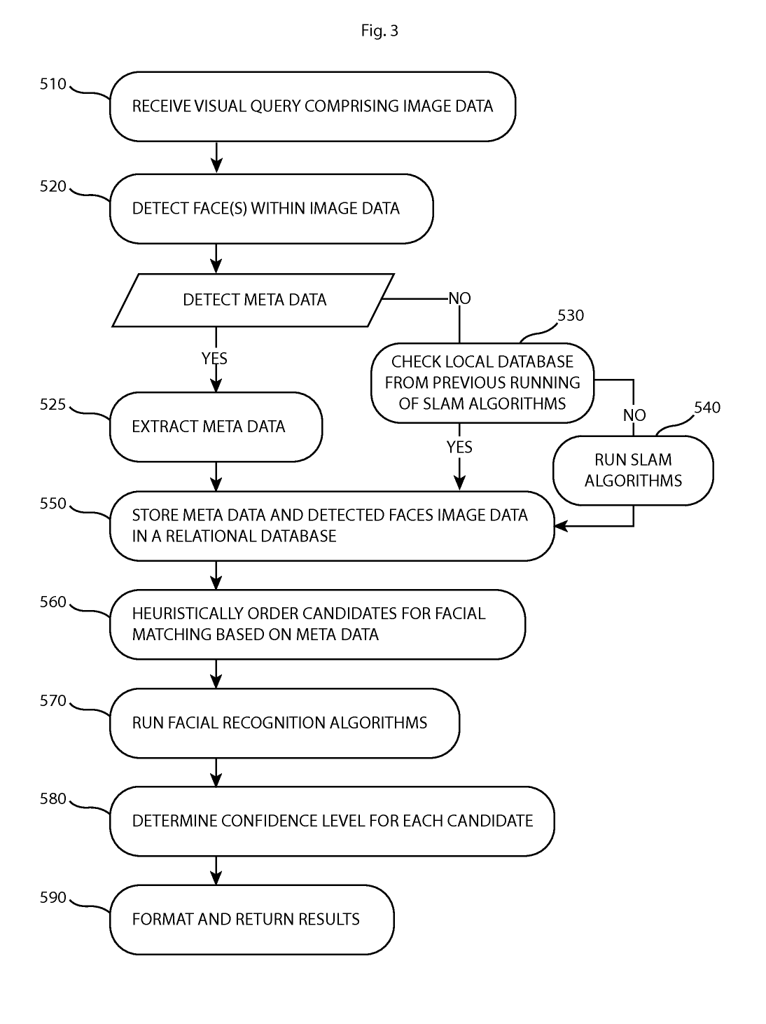

FIG. 3 illustrates an example methodology of performing facial/object recognition according to the present invention. A visual query, comprising image data associated with a user is received (step 510). In step 520 one or more faces are detected within the image data via facial detection software. If metadata is detected, the metadata is extracted from the image data containing faces in step 525. If no metadata is available, in step 530 the system will check a local database to check for the results of previously ran SLAM algorithms. If no data from previously ran SLAM algorithms are available, SLAM algorithms are ran (step 540). It is important to note that for stationary cameras, SLAM algorithms will only need to be run once, and the results will then be stored for future retrieval from a local database, step 530. In step 550, all image data containing detected faces are stored with all associated metadata in one or more relational databases. The data containing possible facial matching-candidates is then heuristically ordered based on the metadata associated with the data of the possible matching-candidates (step 560). A confidence level calculated for each possible matching-candidate in step 570; and facial identification is then performed until the user desired confidence level is attained (step 580)—that is, if the user desires a confidence level of 95%, the first possible matching-candidate that the system determines has a 95% confidence level is the answer, and not further facial identification algorithms will be run. Finally results are formatted and returned to the user in step 590.

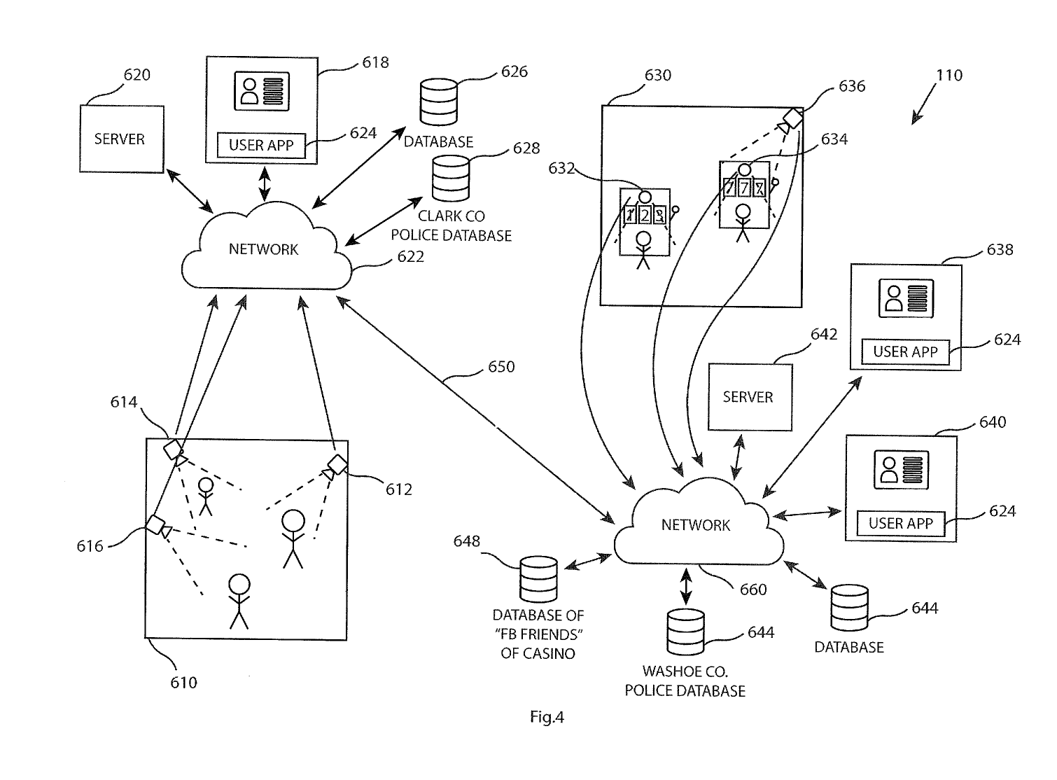

Reference will now be made to an example use case as the system and method of the present invention is best understood within the context of an example of use. Turning to FIG. 4, the system for collecting, linking, processing, and identifying faces or objects from real-time and historical surveillance data is illustrated. Gamblers casino lobby 610 in Las Vegas, Nevada is under surveillance by lobby video cameras 612, 614, and 616 located above the lobby floor. Video cameras 612, 614, and 616 stream live footage of the casino lobby 610, to user system 618, and server 620 through network 622. As illustrated in FIG. 4 user 618, is a desktop computer (or a bank of desktop computers) running user application 224 according to an embodiment of the present invention, and is/are monitored by security personnel of Gamblers casino. Application 224 gathers information about user system 618, such as date, time, location, etc., and transmits the user information and video footage to server 620 via network 622. Server 620 processes the visual query, collecting user information, extracting metadata from the video footage, and running face detection software. Server 620 stores user information, the extracted metadata, and video frames containing detected faces in relational database 626. To aid in identifying detected faces, server 620 can cull the Clark County Police Department's database 628. Identification of any face detected is sent back to users 618, 620 and displayed on the screen of desktop computer (user system 618), augmenting the live footage being streamed; identification is occurring in real time. Identification of detected faces occurs quickly due to the heuristic use of metadata extracted from and associated with the image data obtained from the visual query (queries). While Gamblers Casino is compiling its own database 626, it can add additional remote databases (not illustrated) as storage requirements necessitate. Gamblers Casino in Las Vegas is in communication with its sister casino in Reno, Nevada via private communication link 650 (link is encrypted, line may or may not be private or could use private fiber optic line). The gaming floor 630 of Gamblers' sister casino (in Reno, Nev.) is also illustrated and video cameras 632, 634, and 636 monitor gamers. As illustrated cameras 632 and 634 are embedded within slot machines, while camera 636 is mounted above the gaming floor 630. Cameras 632, 634, 636 transmit live video footage to user systems 638, 640 via network 660. Users systems 638, 640 are desktop computers and run application 624 according to an embodiment of the present invention, and again are monitored by security personnel of Gamblers casino. Application 624 on the desktop computers gathers information about user systems 638, 640, such as date, time, location, and transmits the user information and video footage to server 642 via network 660. Server 642 processes the user information, extracts metadata from the video footage, and stores user information, extracted metadata, and video frames containing detected faces in relational database 644. Additionally, server 642 can access the remote Washoe County Police database 646 as well as remote database 648, which contains image data and metadata associated with “friends” of the Gamblers Casino's Facebook page (that is where Facebook users have “friended” Gamblers Casino). As individuals are captured by any camera (612, 614, 616, 632, 634, 636) at either location (610, 630) application 224 of the present invention automatically (without prompting from users 618, 638, 640) attempts to identify any face detected from the images sent to servers 624, 642. The order in which databases 620, 628, 644, 646, 648 are accessed for identifying potential matching-candidates, and how the image data containing potential matching-candidates stored within databases 628, 644, 646, 648 are rank-ordered based on available metadata, is a neural network model, wherein system 110 determines the “best” way to use the available metadata to rank-order matching-candidates. Once rank-ordered, system servers 620, 642 employ facial recognition algorithms to the first rank-ordered candidate (i.e., most likely matching-candidate) before moving onto the 2^{nd}, 3^{rd}, 4^{th}, 5^{th}, . . . possible matching-candidates. System 110 does not search databases 620, 628, 644, 646, 648 randomly; randomly running facial recognition algorithms, but limits the number of matching-candidates in which comparisons must be made, via its heuristic use of the metadata. Depending on the confidence level required by the user (i.e., Gamblers Casino in FIG. 4) system 110 limits the number of one-to-one comparisons that require computationally time-consuming face recognition algorithms, drastically reducing the time required to identify the face. The lower the confidence level, the quicker results are returned—system 110 is simply relying on its novel rank-ordering of metadata to provide results to the user to a greater extent than it is relying on facial recognition software; the higher the confidence level the greater system 110 will rely on recognition software.

The system and method for collecting, linking, and processing image data to identifying faces or objects is not limited to situations where crime prevention or criminal detection is required. A retail store with locations throughout the Midwest United States might want to implement a new marketing campaign. Before implementing the campaign the store would like to identify the demographic breakdown of its patrons. The customizable system and method of the present invention would be tailored not to identify the individuals captured by security cameras, but to simply return results of the sex and age of shoppers, the date and location of the store visited, time of visit, etc. to store management. The results would not be returned in an augmented reality format as discussed in regards to FIG. 4, where identifying information is displayed directly on the video footage, but would be received in a spreadsheet format allowing the data to be easily sorted. The retail store could not only search and build their own databases, but also access social networking databases such as Facebook and/or LinkedIn to help in determining the sex and age of the shoppers. The metadata extracted from the image data would be used heuristically, rank-ordering potential matching-candidates, before combing different data sets, and linking different types of information to create a profile—linking social networking habits with biometric data, creating a database for innumerable business opportunities. Candidates having metadata associated with a home location not in the Midwest, would be moved to the bottom of the rank-ordering, and would most likely not be reported to the user.

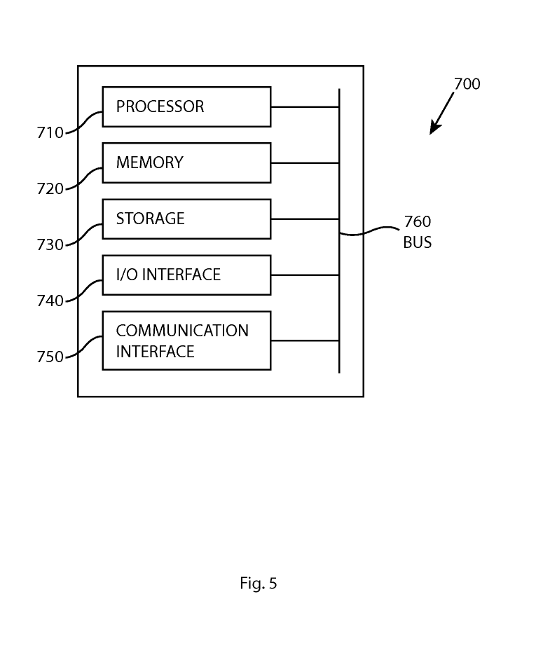

FIG. 5 is an example computer system 700 of the present invention. Software running on one or more computer systems 700 can provide the functionality described herein and perform the methods and steps described and illustrated herein, at different times and or different locations. Computer system 700 may be distributed, spanning multiple locations, span multiple datacenters, and reside in a cloud, which may include one or more cloud components in numerous networks. Example computer system 700 in certain embodiments may include one or more of the following arranged in any suitable configuration: a processor 710, memory 720, storage 730, input/output (I/O) interface 740, and a bus 760. Computer system 700 may be a server, a desktop computer, a laptop computer, a tablet computer, a mobile a phone, or any combination of two or more of these physical embodiments. Processor 710, memory 720, storage 730, input/output (I/O) interface 740, and a bus 760, are all well known in the art as constituent parts of a computer system. In all embodiments computer system 700 implements a software application comprising a computer-readable medium containing computer program code, which can be executed by processor 710 for performing any or all of the steps and functionality of system 110 of the present invention.

The language used in the specification is not intended to be limiting to the scope of the invention. It would be obvious to those of ordinary skill in the art that various modifications could be employed without departing from the scope of the invention. Accordingly, the claims should read in their full scope including any such variations or modifications.

We claim:

1. A computer system for facial recognition comprising:
a processor; and
a non-transitory computer-readable medium storing computer-executable instructions that are configured, when executed by said processor to perform the operations of:
receive a visual query comprising image data;
detect faces within said image data;
extract metadata associated with said detected faces;
link and store said metadata and said image data containing said detected faces in at least one database;
use said metadata heuristically to rank-order said detected faces within said database;
run facial recognition algorithms;
determine a confidence score for said detected faces; and
return results based on said confidence score.

2. The computer system of claim 1 further comprising at a first camera and a second camera for transmitting said visual queries.

3. The computer system of claim 2 wherein said second camera is located remotely from said first camera.

4. The computer system of claim 1 wherein two or more databases are accessed and heuristically rank-ordered.

5. The computer system of claim 4 wherein at least one of said databases is private.

6. The computer system of claim 5 wherein said results include identifying said detected faces.

7. The computer system of claim 6 wherein said results are presented in real time.

8. The computer system of claim 1 wherein said computer system further detects objects.

9. A method for facial recognition comprising, by one or more computer systems:
receiving a visual query comprising image data associated with one or more primary users;
detecting faces within said image data;
detecting metadata associated with said image data;
linking and storing said metadata and said image containing said detected faces in at least one database;
accessing one or more databases to determine possible candidates matching said detected faces;
using said metadata heuristically to rank-order said possible candidates within said database;
running facial recognition algorithms;
determining a confidence score for said detected faces; and
returning results based on said confidence score.

10. The method of claim 9 wherein said metadata is obtained via running simultaneous localization and mapping algorithms and stored in said database.

11. The method of claim 9 wherein at least one of said accessed databases containing said possible candidates is a private database associated with said primary user.

12. The method of claim 9 wherein at least one of said accessed databases containing said possible candidates is a public database.

13. The method of claim 9 wherein said image data comprises frames from a video clip.

14. The method of claim 9 wherein said image data comprises image data from two or more remote locations.

15. The method of claim 9 wherein said results include identifying said detected faces.

16. The method of claim 15 wherein said results are presented in real time.

17. The method of claim 16 wherein said results are presented in augmented reality.

18. The method of claim 9 wherein said results are presented in a proprietary format required by said primary user.

19. The method of claim 9 wherein said image data is obtained from two independent organizations collaborating for a joint goal.

20. A method for object recognition comprising, by one or more computer systems:
receiving a visual query comprising image data associated with one or more primary users;
detecting an object within said image data;
detecting metadata associated with said image data;
linking and storing said metadata and said image containing said detected object in at least one database;
accessing one or more databases to determine possible candidates matching said detected object;
using said metadata heuristically to rank-order said possible candidates;
running object recognition algorithms;
determining a confidence score for said detected object; and
returning results based on said confidence score.
